(19) United States
(12) Patent Application Publication
(10) Pub. No.: US 2009/0219167 A1
(43) Pub. Date: Sep. 3, 2009

(54) Light emitting display device with sequential emission preferably in time with music

(76) Inventors: Peter DeFrancisco, Galena, OH (US); Rene DeFrancisco, Galena, OH (US)

Correspondence Address: D.O. NICKEY, ESQ, 8765 COLVIN DR., PLAIN CITY, OH, 43064, US

(21) Appl. No.: 12/072,718

(22) Filed: Feb. 28, 2008

(51) Int. Cl. G08B 5/38

(52) U.S. Cl. 340/815.4

(57) ABSTRACT

A pre-programmed device and method for forming and displaying images which includes electrically powered light emitters in one or more rows that are preferably sequentially illuminated in time with music, the light emitters are typically a row of lights; a microprocessor(s) controlling the lights; a source of music that will preferably be coordinated with the illumination of the light emitters which enable the display device to convey a message; and a source of electrical power within, on. The inventive display device is useful in displaying a graphic.

### TECHNICAL FIELD

The present invention is a pre-programmed device and method for forming and displaying images, comprising electrically powered light emitters, preferably light emitting diodes (LED's), in one or more generally continuous rows or lines, which are under the control of a microprocessor(s), such that graphics, text, or other images are preferably displayed in time or conformance with music.

### BACKGROUND INFORMATION

There have been devices developed in the past that use multiple lights which are moved to give the illusion of shapes. Representative of such a display device is found in U.S. Pat. No. 6,265,984 to Molinaroli, and the references cited therein. However, there has been no pre-programmed, electrically powered, display device having light emitters under the control of a microprocessor that illuminate the light emitters and controls the pre-programmed music.

### BRIEF SUMMARY OF THE INVENTION

The display device of the present invention preferably includes a non-reflective, tinted or non-tinted cover with spectral light filters to allow day light viewing of displayed images.

The display device of the present invention is a modular device, preferably in the form of a frame for a picture, comprising one or more microprocessor(s), one or more printed circuit (PC) boards, controlling one or more rows of lights, (preferably a plurality of light emitting diodes) a speaker (audio generator for the music), power supply and power control switch.

The microprocessor turns on and off the individual lights in a predetermined sequence and controls the music. Preferably, the lights are turned on and off in step with a microprocessor controlled predetermined musical tune to result in a full image of the desired message. With this invention, a powerful, fun, inexpensive, versatile, light weight display (for example, for a favorite sports team) produces images that are worthy of collection status. Other embodiments include display devices with housings in the shape of game ball trinkets, clocks, miniature hatchets or baseball bats, and other types of items sold at sports matches. Further, the display device is preferably stationary and may be hung from a wall or placed in a display stand.

Thus there is disclosed a pre-programmed device for displaying images, comprising:
(a) a plurality of electrically powered light emitters in one or more generally continuous rows or lines;
(b) one or more microprocessors, the light emitters being under control of one or more of said microprocessors, wherein the microprocessor turns the individual light emitters on and off;
(c) a source of electrical power within, on, or connected to the display device; and
(d) music contained within the microprocessor. The music is played through an audio speaker which is preferably integral with the display device.

### BRIEF DESCRIPTION OF THE DRAWINGS

A more complete understanding of the invention and its advantages will be apparent from the following detailed description taken in conjunction with the accompanying drawings. Like numbers in the drawings relate to the same element in all the drawings. The following drawings are only representative of certain embodiments and should not be construed as limiting.

FIG. 1 is a top plan view of the framed display device with a representative “Script Ohio” on a representative football field (not to scale);

FIG. 2 is a cross section taken though line 2a of FIG. 1 showing some of the various components of the inventive display device;

FIG. 3 is a logic flow diagram which includes the coordination of the lighting of the light emitting devices, preferably also in time with the musical tune; and

FIG. 4 is an electrical drawing showing certain components of a representative display device circuit board.

### DETAILED DESCRIPTION OF THE INVENTION

In the following description, it is to be understood those terms such as “front”, “back”, “within”, “pre-programmed” and the like are words of convenience and are not to be construed as limiting terms. Referring in more detail to the drawings, the invention will now be further described.

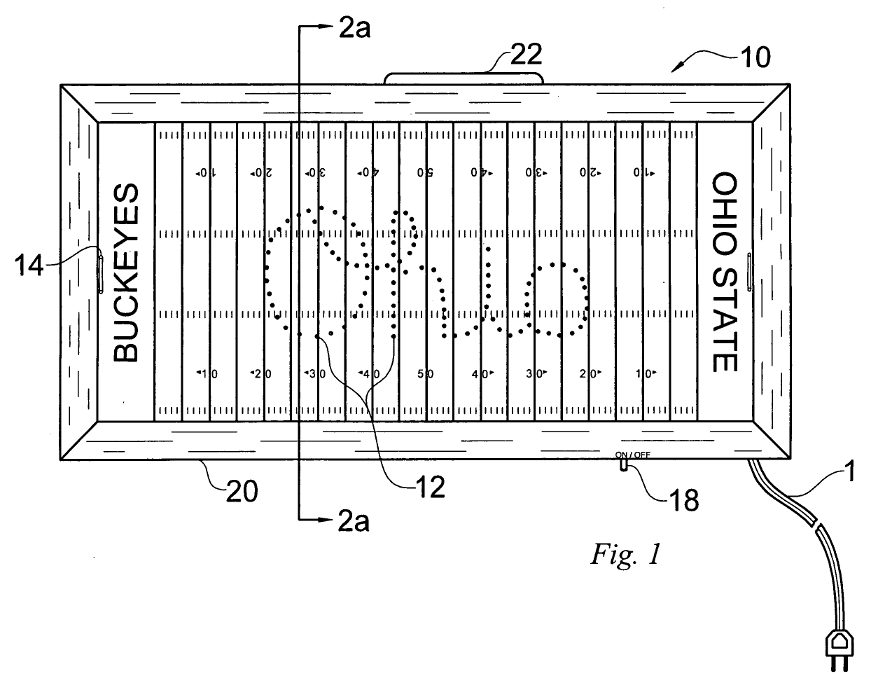

As shown in FIG. 1, this is a pre-programmed display device 10 comprising a plurality of lights, preferably a plurality of LED's 12 in straight or curved rows, under the control of a microprocessor. The frame 20 of the display device 10 can be made of wood or of a synthetic material such as particle board or plastic. The power cord 1 is optional as the display device may be powered by internally contained batteries.

The speaker 22 is for the presentation of the music. Goal posts 14 are also optional for a representative football field. An on/off switch 18 may be located on any portion the display device.

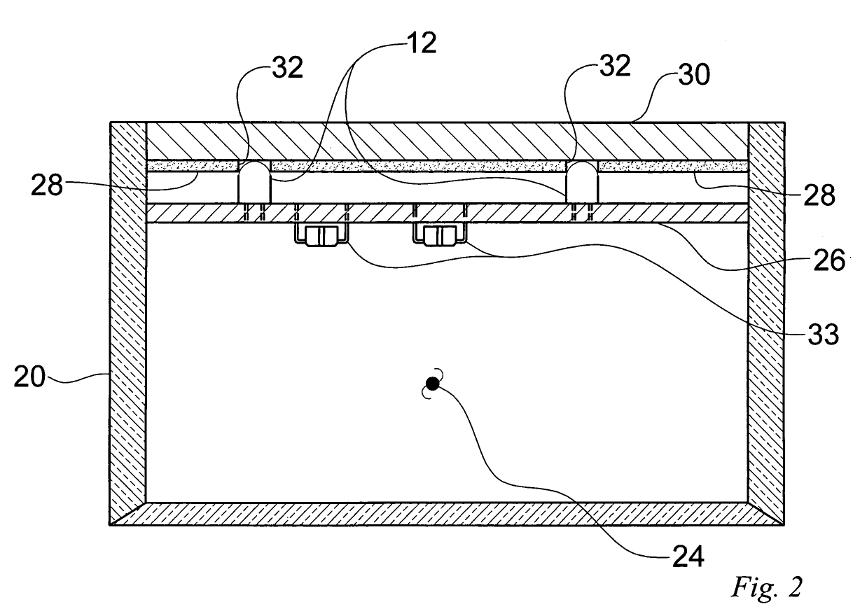

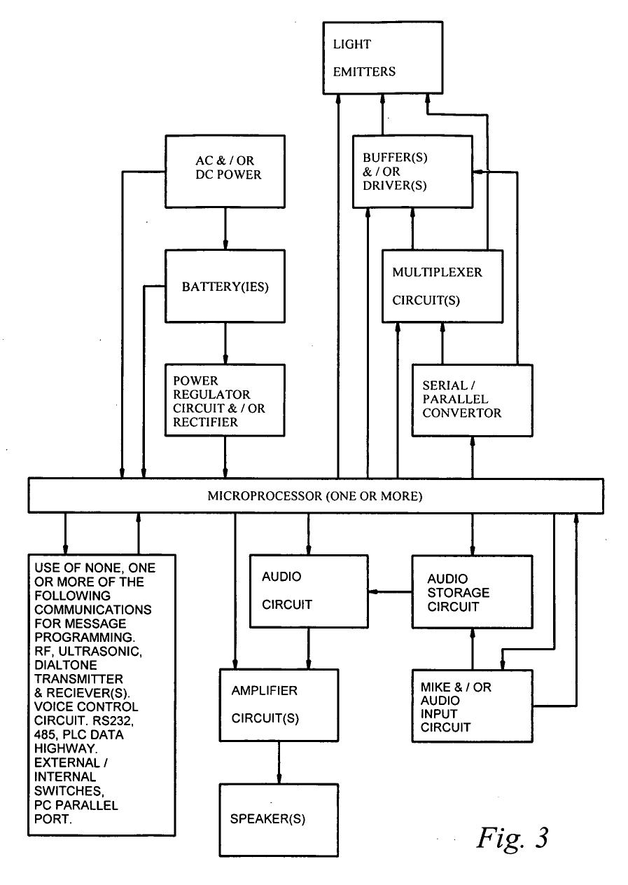

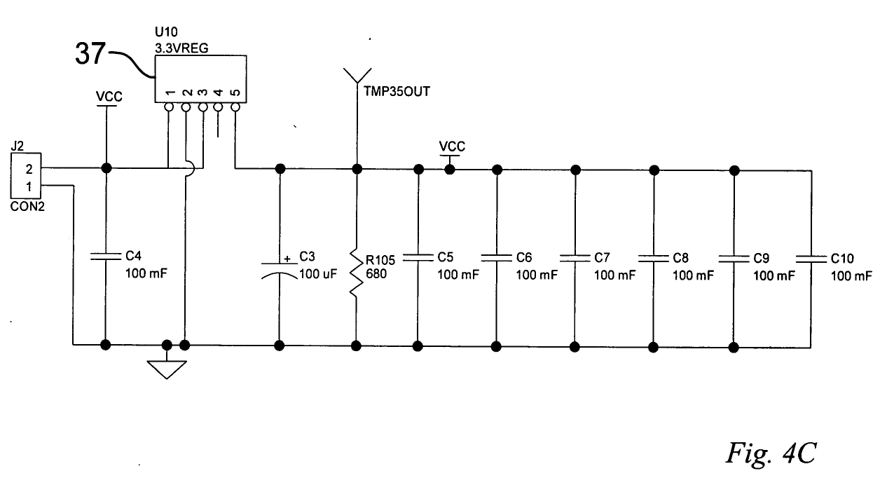

FIG. 2 is a cross section of the inventive device showing the LED's 12 and the frame 20. Item 26 is a circuit board, preferably a printed circuit board (PC board). By “PC board” is meant a printed circuit board which connects the LED'S 12 to the processing units 35 (see FIG. 4) and provides power to the LED's 12.

The covering 30 glass or non-reflective material is adjacent to the display surface 28. The display surface 28 may have an image of a football field, a baseball field, a soccer field or the like. There are openings 32 in the display surface 28 through which the LED's 12 protrude. The transistors, capacitors and resistors of the circuit board 26 are represented by element 33. The space 24 behind the circuit board 26 contains the power supply, speaker 22 and the like. The space 24 can be of any size to accommodate the needed components.

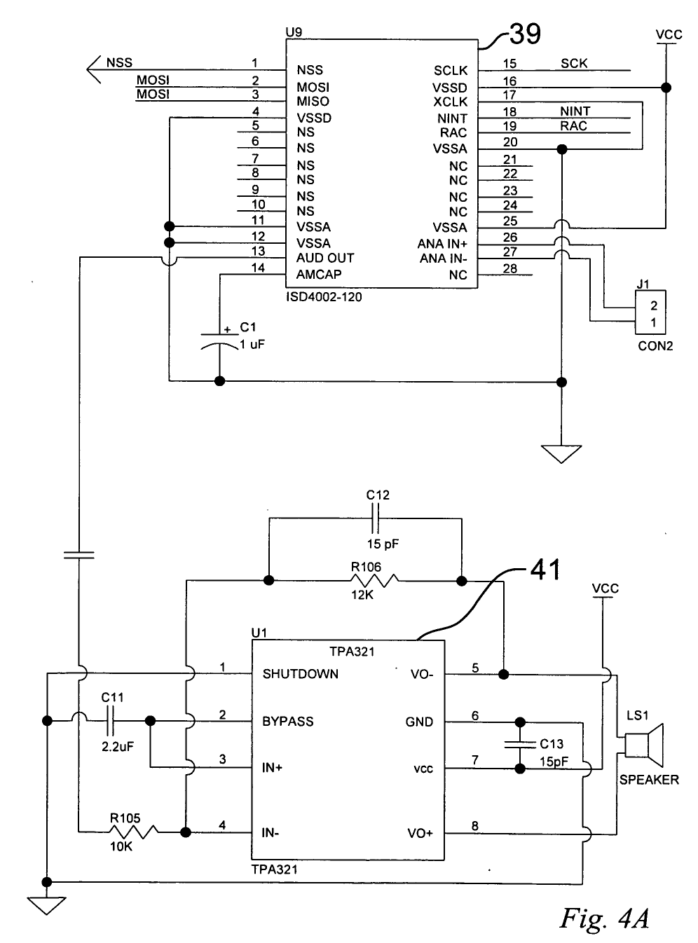

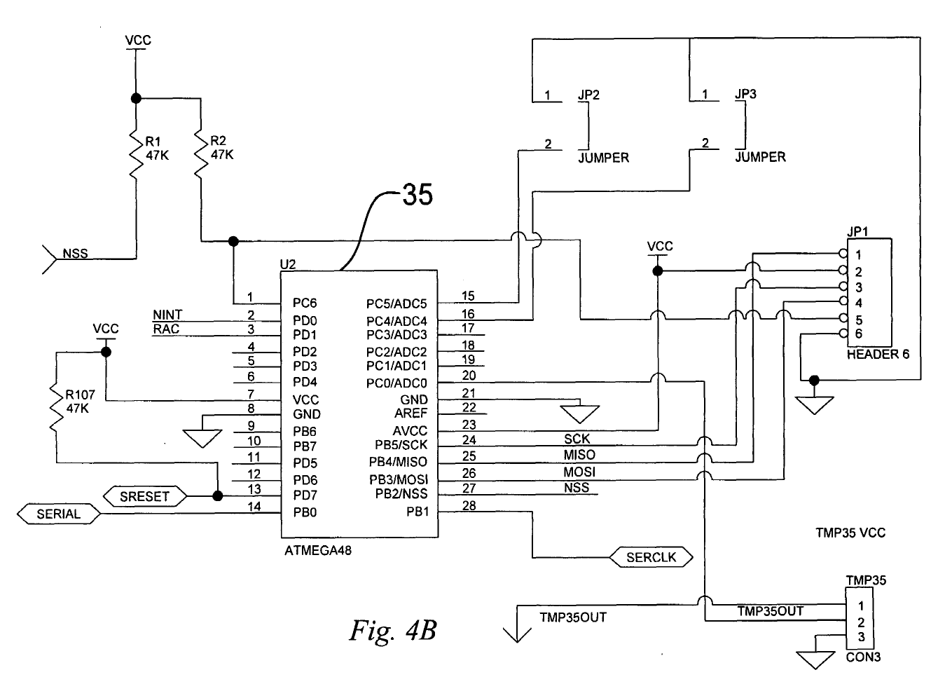

FIG. 3 is a logic flow diagram showing how the microprocessor(s) control the audio and visual aspects of the present invention.

FIG. 4 is a schematic of a representative circuit board wherein element 37 is a voltage regulator, element 39 is audio chip, element 41 is the audio power amplifier and element 35 is the processing unit.

The microprocessor(s) turns on and off the individual LED's 12, preferably in a sequential manner to music. The pictorial display of the present invention may contain a various additional items, such as a clock, a thermometer, a translucent (e.g., tinted) or opaque cover in to allow good visibility during daylight.

Extended memory, such as EEPROM, EPROM, or PROM, is included in the present device to allow extended messages and music. Support devices, such as audio speakers 22 are present to allow for the music installed on the processor to be presented. Further, the present device can be programmed to emit voices, sounds, words and songs. Multicolor LED's 12 are preferred to allow for more colorful displays.

The microprocessor turns the LED's or lamps in the device on and off for short or long periods of time. Various embodiments of the display device according to the present invention are described below. A first embodiment of the present invention is shown in FIGS. 1-4: This display device is designed to operate at any time of day.

The light display device further includes a power supply, such as battery or transformer and a voltage regulator 37 to light the LED's and powers the audio speaker 22. The main microprocessor also controls the second (music section) microprocessor. It is possible to use a serial data IC chip(s), shift registers, multiplexer, etc., in place of the second microprocessor.

The display device of the present invention may use different color LED's allowing the viewer to see a multi-colored, illuminated image, such as scarlet and gray, to represent The Ohio State University. The display device of the present invention will also contain a switch 18 or relay to turn on (enable) power to the microprocessor, the light emitting devices 12 and the sound generator.

Continuing with FIG. 1, the display device further comprises holes to allow emission of audio sounds from a speaker 22 controlled by a microprocessor. The present display device may also comprise a volume controller which is adjustable to accommodate for noisy conditions. The present display device may also comprise an automatic shut off or time delays shut off in order to keep the batteries from accidentally being used up and protect the LED's.

The LED's are mounted in series on the PC board. Single or multi-colored lights may be used. The firing of the different lights can be programmed to produce color symbols and figures containing many different colors.

To power this device, on-board replaceable or rechargeable batteries can be used. In the alternative, the display device can use standard AC current with or without a transformer, which are connected to voltage regulator 37. A voltage regulator circuit and supporting components are not necessary if the type and quantity of batteries are chosen so that the voltage remains in the realm of the processor's operating capabilities. In the embodiment where batteries are used, the display device will have a battery door.

Body parts are designed for ease of assembly and operator usage. The proposed construction required for manufacture of the device, saves time and over-all cost.

In one embodiment of the invention the display device comprises a flexible PC board. A PC board made of thin flexible plastic can save construction time and cost by eliminating standard-type metal terminals. The present invention could also be used as a window display device for the home and/or car. The display device can be attached to a side window, preferably the inside, of an automobile, truck, or any other type of vehicle.

As shown in FIG. 1, the main display board is supported by a box frame comprising: two horizontal supports and two vertical supports. The inventive display device may be hung from a wall, placed in a stand or attached to a car window.

FIG. 4, though not inclusive, shows some of the electrical components which may be employed in the present device. The display unit would include a microprocessor, display lights, a device for display timing, a source of music and a power source. Possible additional components and their interactions with other components are contemplated herein.

When the microprocessor is powered up, the program starts with preliminary items, such as authorizing ports, setting timers, putting values into RAM, and setting of variables. Multiple microprocessors can be used. One microprocessor will be the supervisory processor which sends serial data each time it accesses the alphanumeric/graphics data. In this embodiment of the invention the costs of production are reduced since no data storage or timing algorithm is needed in the subordinate processors unless it is desired to oscillate the output to change the color of the LEDs. On programmable displays, this can be done in many ways. The device may also contain a light sensor device or a communications device for enabling the display device. There may also be a means of programming, or visually indicating to a user what is being programmed through the use of a personal computer, Internet Service Provider (ISP) connection, portable computing device, pager interface, cell phone interface, infrared remote, radio frequency (RF) remote, photo sensor, liquid crystal display, or digital signal processor for voice control and programming. This will device to allow a user to configure and or program the device for display.

Also included herein is a method of forming and displaying images, comprising the steps of:
a) providing a row or rows of light emitting diodes on a display surface;
b) enabling a microprocessor within the device;
c) starting a pre-programmed microprocessor lighting algorithm;
d) sequentially lighting light emitting diodes in a pre-programmed pattern, thereby causing the microprocessor to display portions of characters or graphics; and
e) playing music controlled by said micro-processor.

Preferred embodiments of the invention have been described using specific terms, but it will be apparent to those of ordinary skill in the art that various modifications may be made without departing from the spirit or scope of the invention. Such modifications are intended to be within the scope of the present invention as defined by the following claims. It is intended that the doctrine of equivalents can be relied upon to determine the fair scope of these claims in connection with any other person's product which falls outside the literal wording of these claims, but which in reality does not materially depart from this invention.

We claim:

1. A display device for displaying images, comprising:
(a) a plurality of electrically powered light emitters in one or more generally continuous rows,
(b) at least one microprocessor, the light emitters being under control of said at least one microprocessor, wherein said microprocessor turns individual light emitters on and off in a time-controlled manner, in order that graphics, words or messages are displayed;
(c) a source of electrical power within, on, or connected to the display device; and
(d) an audio speaker under the control said microprocessor.

2. A display device according to claim 1, further comprising a frame, a display surface and an on/off switch.

3. A display device according to claim 2, wherein the device comprises a power connector for connection to an outside power source, and the light emitters are light emitting diodes.

4. A display device according to claim 2, wherein the display device further comprises a microprocessor for the illumination of said light emitting devices in time with music.

5. A display device according to claim 2, further comprising a display surface with the image of a football field.

6. A display device according to claim 1, further comprising a printed circuit board and a voltage regulator.

7. A display device according to claim 1, further comprising a covering selected from the group consisting non-reflective, tinted or non-tinted material.

8. A display device according to claim 2, wherein said device illuminates said light emitters in time with music.

9. A display device according to claim 2, further comprising a time delay switch.

10. A display device according to claim 2, further comprising a means of programming, or visually indicating to a user what is being programmed through the use of a Personal Computer, Internet Service Provider (ISP) connection, portable computing device, pager interface, cell phone interface, infrared remote, radio frequency (RF) remote, push button, photo sensor, Liquid Crystal Display, or Digital Signal Processor for voice control and programming.

11. A display device according to claim 10, further comprising a digital memory device connected by conductors to the microprocessor to allow data storage.

14. A display device according to claim 1, further comprising a plurality of multicolored light emitting diodes that can change color, multiple colored lights, or spectral filters for color changes.

15. A display device according to claim 14, further comprising light pipes for transmitting light for the display from one point location to another.

16. A display device according to claim 15, wherein the lights are mounted in a display panel.

17. The device according to claim 1, further comprising a clock and a thermometer.

18. A method of forming and displaying images, comprising the steps of:
a) providing a row or rows of light emitting diodes on a display surface;
b) enabling a microprocessor within the device;
c) starting a pre-programmed microprocessor lighting algorithm;
d) sequentially lighting light emitting diodes in a pre-programmed pattern, thereby causing the microprocessor to display portions of characters or graphics; and
e) playing music controlled by said micro-processor.

19. A pre-programmed device for displaying images, comprising:
(a) a plurality of electrically powered light emitters in one or more generally continuous rows, the light emitters comprising a plurality of multicolored light emitting diodes, light emitting diodes that change color, multiple colored lights or spectral filters for color changes;
(b) one or more microprocessors, the light emitters being under the control of at least one of the microprocessors;
(c) wherein said microprocessor turns the individual light emitters on and off in a time-controlled manner, in order that graphics, words or messages are displayed.
